(19) United States
(12) Patent Application Publication
(10) Pub. No.: US 2010/0076852 A1
(43) Pub. Date: Mar. 25, 2010

(54) System and Method for Accelerating the Sale and Increasing the Value of a Property

(75) Inventors: Ori Lapidot, Parkland, FL (US); Gary M. Schnabolk, Parkland, FL (US)

Correspondence Address: Sunstein Kann Murphy & Timbers LLP, 125 SUMMER STREET, BOSTON, MA, 02110-1618, US

(73) Assignee: CROSS COUNTRY HOME SERVICES, INC., Sunrise, FL (US)

(21) Appl. No.: 12/563,803

(22) Filed: Sep. 21, 2009

Related U.S. Application Data
(60) Provisional application No. 61/098,482, filed on Sep. 19, 2008.

(51) Int. Cl. G06Q 50/00; G06Q 30/00; G06Q 40/00; G06Q 10/00

(52) U.S. Cl. 705/14.72; 705/34; 705/302; 705/316

(57) ABSTRACT

A method for accelerating the sale of a property includes providing a seller with a warranty on some or all of the seller's foreclosed and bank owned properties. The method then bills the seller for the warranty when the property is sold.

### PRIORITY

This patent application claims priority from U.S. Provisional Application No. 61/098,482, filed Sep. 19, 2008, entitled, “System and Method for Accelerating the Sale of Properties,” assigned attorney docket number 3282/102, and naming On Lapidot and Gary Schnabolk as inventors, the disclosure of which is incorporated herein, in its entirety, by reference.

### FIELD OF THE INVENTION

The invention generally relates to the sale of real estate properties, more particularly, the invention relates to systems and methods for accelerating the sale of a property.

### BACKGROUND

It is estimated that approximately 30% of today's home sales are distressed inventory (e.g., short sales, foreclosures, and other bank owned properties). An additional two to four million properties are expected to be in foreclosure in the next two years. As one would expect, the large number of bank owned properties negatively impacts the general state of the economy as well as slows the housing market dramatically.

Additionally, many of the homes included in the distressed inventory may have been unoccupied and, in extreme cases, neglected for a period of time. This, in turn, reduces a buyers confidence in the quality of the home, drives down the price at which the property may be sold, and increases the length of time that the property remains on the market. As additional distressed inventory comes onto the market, the values of surrounding homes (including those that are not distressed) may also be at risk.

### SUMMARY OF THE INVENTION

In accordance with embodiments of the present invention, a method may accelerate the sale of a property. The method may include providing a seller (e.g., a bank, mortgage lender, government agency, investor, etc.) (or the real estate agent responsible for selling the property) with a warranty on some or all of the foreclosed and bank owned properties in the mortgage company's inventory. The method may also include billing the seller for the warranties once the property is sold. The seller or real estate agent can include the cost of the warranty in the sale price of the property. In order to maximize the term of the warranty for the purchaser of the property, the term of the warranty may begin on or after the closing of the property. In some embodiments, the warranty may be a multi-year warranty and the seller may be billed for the entire cost of the warranty at the time of closing of the property. The warranty may increase the value and salability of the foreclosed and bank owned properties.

In other embodiments, the warranty does not cover missing appliances, missing home systems, rust and corrosion, and/or abuse to the home. Abuse to the home may include intentional or neglectful damage to the air conditioning systems, heating systems, kitchen appliances, and laundry appliances, to name but a few.

In accordance with other embodiments of the present invention, a system may implement the techniques and methods described above. The system may include a series of interconnected modules and components. Specifically, the system may include a warranty module and a billing module. The warranty module may provide the warranty on some or all of the mortgage lender's foreclosed and bank owned properties. The billing module may bill the seller for the warranty once the foreclosed and/or bank owned property (e.g., the distressed property) is sold.

In accordance with further embodiments, the seller or real estate agent may include the cost of the warranty in the sale price of the foreclosed and/or bank owned property. Further, the warranty module may provide a multi-year warranty, and the billing module may bill the seller for the entire cost of the warranty. The term of the warranty may begin after the closing on the property. Further, the warranty may not cover missing appliances, missing home systems, rust and corrosion, and abuse to the home (e.g., intentional or neglectful damage to air conditioning systems, heating system, kitchen appliances, laundry appliances, etc.).

In accordance with additional embodiments, the system may also have an information receiving module, an extraction module, and a list generation module. The information receiving module may receive information regarding the plurality of distressed properties from a system user. The extraction module may then extract a subset of the property information from the received information, and the list generation module may generate a list of the plurality of distressed properties. The list may include the extracted information and warranty options for the distressed properties.

The system may also have a material preparation module that prepares customized marketing and sales materials based, at least in part, upon the extracted property information and warranty options selected by the system user. The user may be a bank, a mortgage lender, or a real estate agent listing the property. A cost generation module may calculate the cost of the warranty based, at least in part, upon the extracted property information and the selected warranty options. The billing module may then bill the mortgage company for the calculated cost of the warranty. The term of the warranty may begin after the property is sold (e.g., after closing) and the warranty module may initiate the warranty term after closing.

In accordance with still further embodiments, a system for accelerating the sale of a property may include a means for providing a warranty to a seller for some or all of the mortgage company's foreclosed and bank owned properties (e.g., distressed properties). The system may also include means for billing the seller for the warranty once the property is sold. The means for providing may also offer the warranty to a real estate agent responsible for selling the property. The warranty increases the value and salability of property, and the cost of the warranty may be included in the sale price of the property.

The means for providing a warranty may provide a multi-year warranty, and the means for billing may bill the seller for the entire cost of the warranty at the time of closing. The warranty may not cover missing appliances, missing home systems, rust and corrosion, and abuse to the property (e.g., intentional or neglectful damage to air conditioning systems, heating system, kitchen appliances, laundry appliances, etc.). The term of the warranty may begin at the closing of the property.

In accordance with further embodiments of the present invention, a computer-implemented method for accelerating the sale of a property may include receiving, within a computer, property information regarding at least one distressed property from a user over a global communication network. The method may then extract, within a computer process, a subset of the received information, and prepare, within a computer process, customized marketing and sales materials for the at least one distressed property. The customized materials may be based, at least in part, upon the extracted information, and the materials may aid the user in accelerating the sale of the property. The customized marketing and sales materials may relate to warranty coverage for the at least one distressed property.

Moreover, the computer-implemented method may also generate and display, in a computer process, a list of warranty features (e.g., a list of appliances contained within the distressed property, a list of utilities equipment contained within the distressed property, a length of warranty coverage, and warranty deductible options) for the at least one distressed property. The list of warranty features may allow a user to select at least one warranty feature for the distressed property. The customized marketing and sales materials may be based upon the selected warranty features. Once the features are selected, the method may calculate, in a computer process, the cost of the warranty based, at least in part, upon the selected warranty features.

The computer-implemented method may also bill, using a computer, an entity for the calculated cost of the warranty (e.g., after the at least one distressed property is sold), and initiate the warranty coverage for the distressed property. The warranty coverage may include the selected warranty features and may start after the property is sold. The entity may be, for example, a bank or a mortgage lender that owns the property. The system user may be the bank, the mortgage lender, or a listing agent.

In accordance with additional embodiments of the present invention, a computer program product for use on a computer system for accelerating the sale of a property may include a computer readable medium having computer readable code thereon. The computer readable program code may include computer code for receiving property information about at least one distressed property. The information may be received from a user over a global communication network. The computer readable program code may also include computer code for extracting a subset of the received information, and computer code for preparing customized marketing and sales materials. The customized marketing and sales materials for the distressed property may be based, at least in part, upon the extracted information. The customized marketing and sales materials may aid the user in accelerating the sale of the property and may describe warranty coverage for the distressed property.

The computer program product may also include computer code for generating a list of warranty features for the distressed property, and computer code for displaying the list of warranty features to allow a user to select at least one warranty feature for the distressed property. The customized marketing and sales materials may describe the selected warranty features.

Moreover, the computer program product may include computer code for calculating a cost of the warranty based, at least in part upon the selected warranty features. Additionally, the product may have computer code for billing an entity for the calculated cost of the warranty, and computer code for initiating warranty coverage. The entity may be billed and the warranty coverage may start after the distressed property is sold.

### BRIEF DESCRIPTION OF THE DRAWINGS

The foregoing features of the invention will be more readily understood by reference to the following detailed description, taken with reference to the accompanying drawings, in which:

FIG. 1 shows a flowchart showing the steps of one method for accelerating the sale of a property in accordance with one embodiment of the invention.

FIG. 2 schematically shows a system for accelerating the sale of a property in accordance with embodiments of the present invention.

FIG. 3 schematically shows a block diagram of a computerized method for accelerating the sale of properties, in accordance with an embodiments of the present invention.

FIG. 4 schematically shows an alternative embodiment of a system for accelerating the sale of properties, in accordance with additional embodiments of the present invention.

FIG. 5 schematically shows a flowchart of the enrollment and renewal process in accordance with various embodiments of the present invention.

FIG. 6 schematically show a flowchart for the processing of files and information received by various embodiments of the present invention.

FIG. 7 schematically shows a flowchart for an alternative method in accordance with embodiments of the present invention.

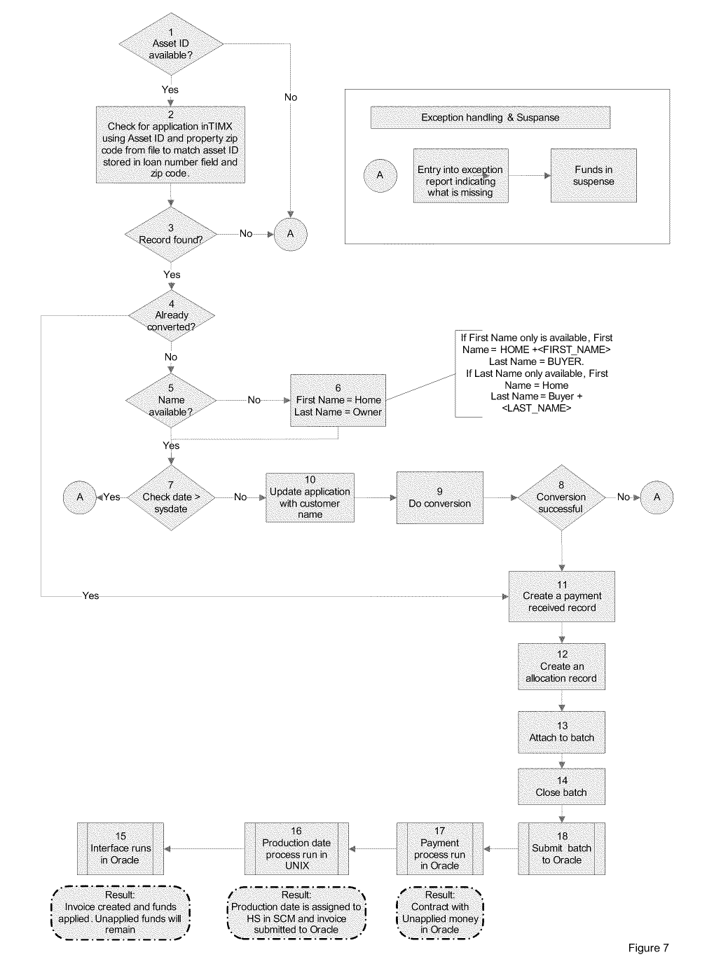

FIG. 8 schematically shows a flowchart for a method of automatically renewing warranty contracts, in accordance with some embodiments of the present invention.

### DESCRIPTION OF ILLUSTRATIVE EMBODIMENTS

As mentioned above, the number of foreclosures and other bank owned properties (e.g., short sales) are increasing at an alarming rate. This increase in the number of foreclosed and distressed inventory negatively impacts the general economy, and has a devastating impact on the housing market.

Once a home is foreclosed upon or the bank takes ownership of the property, the bank, mortgage lender, or other seller becomes responsible for maintaining the property and making all tax and insurance payments on the property. Many of the homes and properties that the bank/mortgage lender take over have been neglected for substantial periods of time. In some instances, the prior owners intentionally damaged the property or removed fixtures (e.g., heating and A/C units, copper piping, light fixtures, etc.) in an attempt to sell the fixtures at a profit. Furthermore, because banks and mortgage lenders are not structured and/or prepared to maintain the large number of properties, the homes and properties may fall into further disrepair once the bank/mortgage lender takes over the property.

In today's housing market, well maintained and non-bank owned properties are remaining on the market for extended periods of time. Accordingly, it is not surprising that the bank owned properties that are in less than perfect condition take even longer to sell. It is currently estimated that the average foreclosed property takes approximately 6-18 months to sell. During this time, the bank or mortgage company is losing revenue as a result of the mortgage default and the cost for maintaining the property. Additionally, once the property does sell, the banks and mortgage lenders are typically forced to take a loss on the property and write-off any difference between the mortgage balance and the sale price of the foreclosed home.

Nearly every foreclosed and short-sale property is sold “as-is,” meaning that the bank and/or mortgage lender is not responsible for any problems/defects with the home (e.g., leaking roof, burst pipes, damage to the heating and A/C units, etc.).

In other words, the potential buyer of the foreclosed property will be unable to have the seller (e.g., the bank or mortgage lender) fix the problems with the house or have the bank/mortgage lender pay for the repairs. Although this somewhat protects the bank and/or mortgage lender from the financial responsibility of repairing the property, very often the “as-is” nature of the sale and the condition of the home make potential buyers uneasy. Therefore, many buyers either walk-away from such properties or make offers that are well below market value.

The general goal of the bank or mortgage lender is to sell the foreclosed property as quickly as possible for as much as possible. However, the condition of the home, the “as-is” nature of the sale, and the general state of the housing market typically force the bank/mortgage lender to hold on to the property for long periods of time and to take a large loss.

Various embodiments of the present invention provide systems and methods for accelerating the sale of foreclosed and other bank owned properties (e.g., distressed properties). Specific embodiments offer a home warranty to the bank or mortgage lender and postpone billing until the sale of the property is final (e.g., the closing on the property). This, in turn, makes the property more attractive to potential buyers and helps the bank/mortgage lender sell the property faster and for a higher price. Details of illustrative embodiments are discussed below.

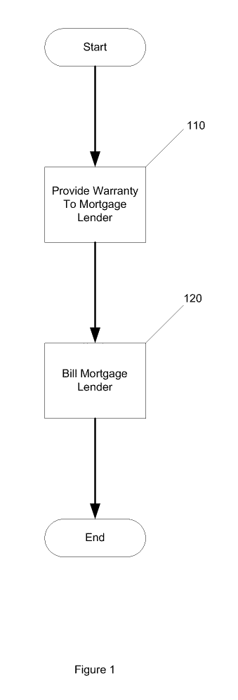

FIG. 1 shows one embodiment of a method in accordance with the present invention. According to the method 100, a home warranty company or other home maintenance company can provide the seller (e.g., bank, mortgage lender, investor, government agency, etc.) with a warranty on the foreclosed and other bank owned properties (Step 110). The seller can select certain homes (e.g., the more damaged, neglected, or those properties in greatest state of disrepair) that they wish to obtain warranties for or the seller can simply choose to obtain warranties on their entire inventory of properties.

The warranty can be for a variety of terms (e.g. one year, two years, three years, etc.) and may cover a variety of the components of the home. For example, the warranty may cover anything that goes wrong with the electrical or plumbing in the home. Additionally, the warranty may also be structured such that it does not cover other aspects of the home. For example, the warranty can be structure such that it does not cover missing appliances and systems (e.g., refrigerator, stove, A/C system), rust, corrosion, intentional or negligent abuse (e.g., to air conditioning and heating systems, kitchen and laundry appliances, etc.).

Once the seller obtains the warranty provided to them by the home warranty company, the seller may then market the property as “under warranty.” The presence of the warranty provides an advantage over similar homes without warranties, and may accelerate the sale of the property. In addition, since damage and problems with the property may be covered under warranty, potential buyers will be more confident in their purchase and may be more likely to offer a higher price for the home. Moreover, once the buyer is in the home, the cost of many repairs (or the cost of replacing appliances, etc.) will be covered under the warranty. Therefore, the buyer will not be subject to unexpected expenses that may make it difficult for the buyer to pay the new mortgage.

As mentioned above, the sellers are responsible for the properties maintenance until the property is sold. Therefore, it is unlikely that the seller will be willing to outlay additional cash for a warranty on a home that has not sold yet. Accordingly, method 100 may not bill the seller for the warranty until the property sells (Step 120). For example, the seller may not be required to pay the premium for the warranty until the closing of the property. Furthermore, because the seller knows the cost of the warranty up front, they are free to include the cost of the mortgage into the price of the property. Therefore, the seller is able to pass the cost of the warranty on to the purchaser and minimize additional expenses associated with the sale of the property.

When the home warranty provider bills the seller for the cost of the warranty, the home warranty provider may bill for all or part of the home warranty premium. For example, if the seller obtains three-year home warranties, the home warranty company can either bill for just the first year of the warranty, or they may bill for the entire three-year premium. Also, to maximize the length of the warranty for the purchaser, the term of the warranty may begin at the time of closing (e.g., the time that the house was on the market will not count against the term of the warranty).

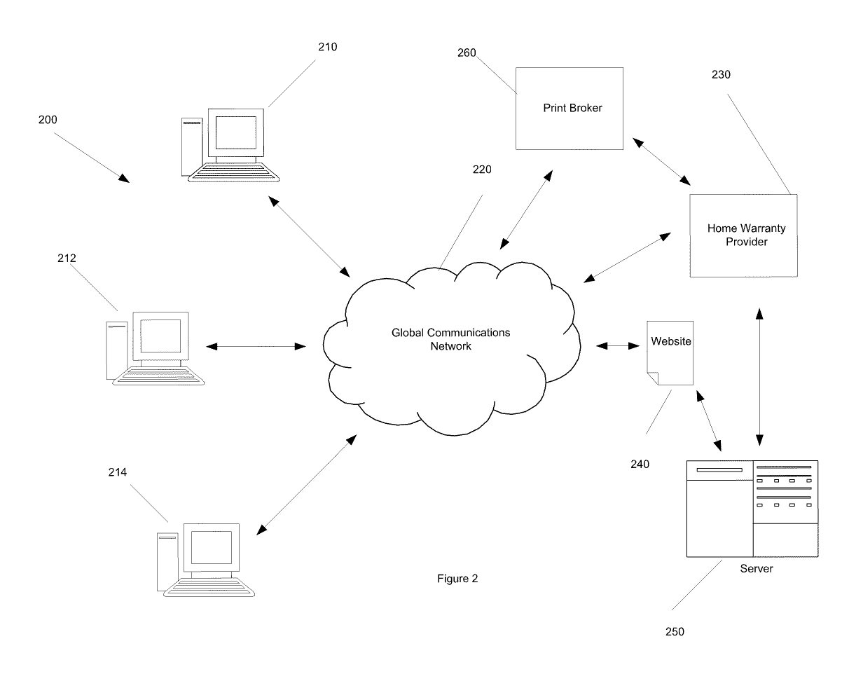

As mentioned above and as shown in FIG. 2 some embodiments of the present invention may be implemented as a system 200. For example, the system 200 may include a global data communications network 220, such as the internet. The system 200 may also include a server 250 that is in communication with the global communications network 220 and supports a website 240. The website 240 may consist of a plurality of web pages. The system 200 may also include one or more customer terminals 210/212/214, such as workstations within the banks, mortgage lenders (e.g., those institutions with an inventory of foreclosed homes which they wish to sell), or the real estate agent listing the property.

The customer terminals 210/212/214 may be in communication with the global communications network 220 to allow the customer terminals 210/212/214 and seller (or the real estate agent listing the property) to access the website 240. For example, the website 240 may be accessed and displayed by the workstations 210/212/214 over the global communications network 220. Further, the workstations 210/212/214 may send information back to the server 250 over the global communications network 220.

The system 200 may also include a home warranty service provider 230. The home warranty service provider 230 may access and view the website 240 and access any data stored within the server 250. The home warranty service provider 230 may also send information back to the server 250 over the global communications network 220.

As discussed in greater detail below, some of the embodiments of the present invention prepare customized marketing and sales materials to be used by the listing agent when selling the property. For example, some embodiments may prepare signage (e.g., to be included on the for-sale sign, the lock-box, etc.), take-away materials for potential buyers, displays for the take-away materials, and stickers for adhering to appliances and other equipment (e.g., HVAC, water heaters, etc.) that are covered by the warranty. To that end, the system 200 may also include a print broker 260. The home service warranty provider 250 may send the print broker 260 (e.g., directly or over the global communications network 220) information regarding the warranty and the properties for sale. The print broker 260 may then, in turn, prepare the customized marketing and sales material for each of the properties for sale.

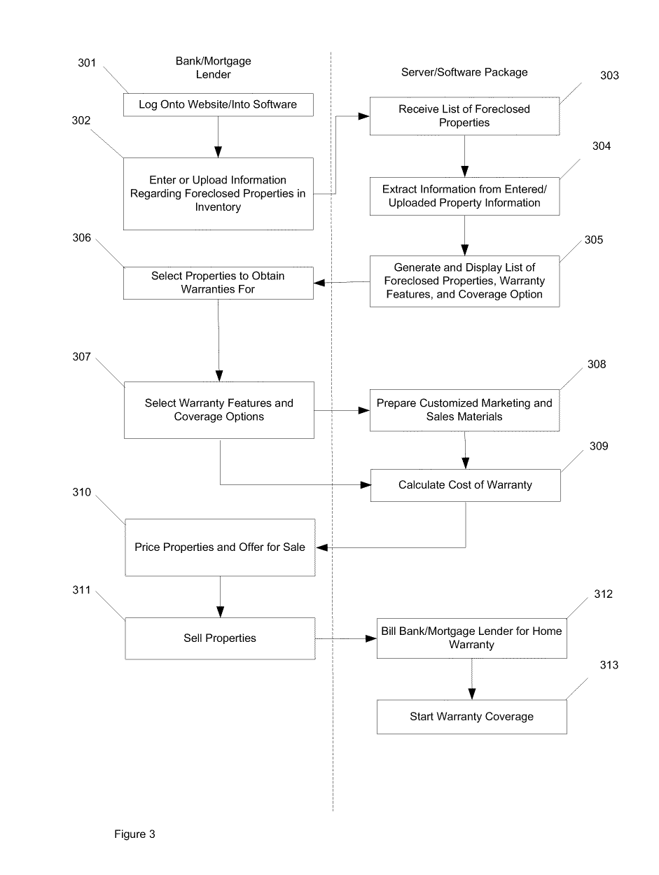

FIG. 3 shows a computerized method for accelerating the sale of properties in accordance with some embodiments of the present invention. As shown in FIG. 3, a user (e.g., the seller, the bank, the mortgage lender, or the real estate agent listing the property) may log onto the website 240 or software package (Step 301), for example, using one of the workstations 210/212/214 shown in FIG. 2. Once logged-in, the seller/bank/mortgage lender/agent may input information regarding the foreclosed properties in their inventories (Step 302). For example, the user may manually input (e.g., by typing) the information regarding the properties (e.g., address, condition and age of property, condition and age of appliances and utility equipment, etc.) or the user may upload the information (e.g., from a hard-drive, other memory on the workstation 210/212/214, or from an external memory device).

Once the foreclosed property information is entered/uploaded, the server 240 or the software package may receive the property information (Step 303), extract all or a subset of the inputted/uploaded information (e.g., the property address, property description, the listing agent, information regarding the properties utilities and appliances, etc.) (Step 304), and generate and display a listing of the properties and corresponding information, as well as a list of warranty features and coverage options (Step 305) for each property.

The user (e.g., the seller, the bank, mortgage lender, or real estate agent) may then select the properties for which they wish to obtain warranty coverage (Step 306) and the corresponding warranty features they wish for each property (Step 307). In some instances, the user may wish to obtain coverage for all of the properties. To that end, the system (e.g., the server or the software package), may allow a user to easily select all of the properties listed. For example, the website 240 or software package may have a select all function which allows the user to select all of the properties by clicking a single button.

As mentioned above, in addition to the listing of the properties, the system may generate and display a list of home warranty features and coverage options (e.g., step 305), and the user may then choose and customize coverage for each of the properties (e.g., steps 306 and 307). For example, the user may select which appliances (e.g., stove, refrigerator, etc.) and utilities (e.g., electrical, plumbing, HVAC) to cover as well as the type, length, and amount of coverage, including whether or not there is a deductible.

Based upon the home warranty features selected and the property information, the method may then prepare customized marketing and sales materials for the individual properties and provide the materials to the user (Step 308). For example, as discussed above, the customized marketing materials may include signage, take-away materials, and other materials that contain information regarding the property and the warranty coverage of the property. As also discussed above, the bank/mortgage lender/listing agent may then use these materials to help sell the property.

The computerized method may then calculate the cost of the warranty and provide this cost to the user (Step 309). The cost of the warranty may be based upon a variety of factors including, but not limited to, the warranty features and coverage options selected and the inputted/uploaded property information (e.g., the age and condition of the appliances and property, etc.). As mentioned above, various embodiments of the present invention allow banks and mortgage lenders to market their properties as “under warranty” and they may add the cost of the warranty into the cost of the home. Accordingly, once the user (e.g., the bank/mortgage lender/listing agent) receives the cost of the home warranty, the user may price the property (e.g., by taking into account the cost of the warranty) and offer the property for sale (Step 310).

In some embodiments, the system (e.g., the server or the software package) may be connected to a secondary system that the seller/bank/mortgage lender/agent may use to market their properties. For example, some embodiments of the present invention may be connected (e.g., via the internet or otherwise) to the seller/bank/mortgage lenders website, the listing agent's website, the multiple listing service (e.g., the “MLS”) or other on-line listing service. This allows the user to automatically transfer pricing, property information, and warranty information to the property's for sale listing.

Once the properties are on the market (e.g., listed on the MLS, website, etc.), the seller, bank, mortgage lender, or listing agent may then market and sell the property as “under warranty” (Step 311). As mentioned above, in some embodiments, the seller is not billed for the warranty and the warranty coverage does not start until the property sells. To that end, when the property is sold, the seller, bank, mortgage company, listing agent, or closing agent may notify the warranty provider of the sale. For example, the closing agent may send/input the closing information into the computerized method or enter the information via the website 240. Once the closing information is received, the computerized method may then bill the seller/bank/mortgage lender for the home warranty (Step 312) and start the warranty coverage (Step 313).

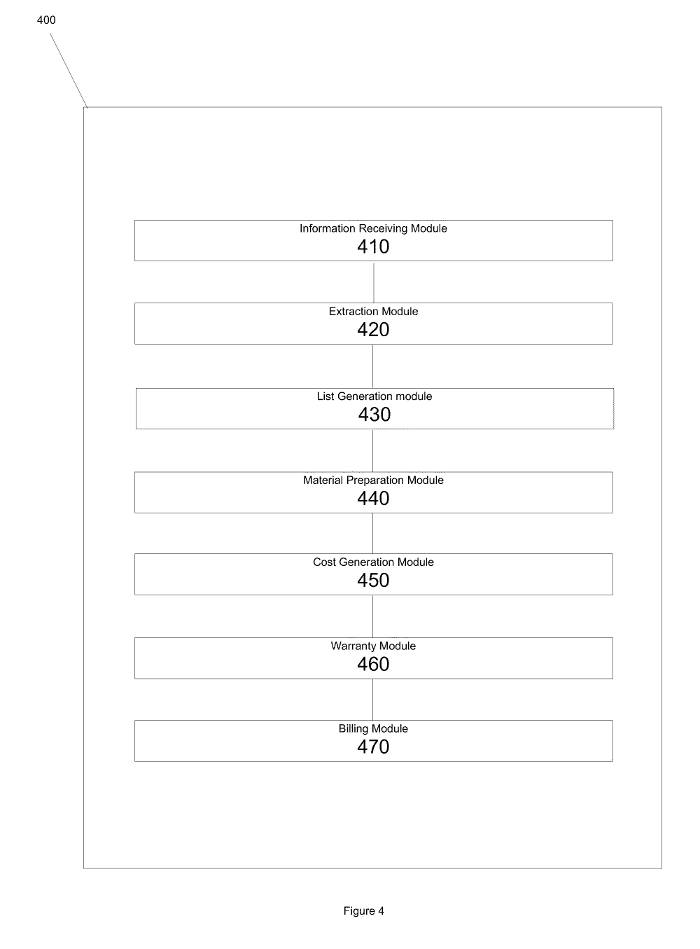

As shown in FIG. 4, some embodiments of the present invention may include a variety of interconnected modules that perform the functions and steps discussed above. In particular, some embodiments may include an information receiving module 410 that receives the property information that is inputted and/or uploaded to the system 200 or software package (e.g., by the user). Once the information is received, the information receiving module 410 may transfer the information to an extraction module 420 that extracts the required information (e.g., all or a subset of the inputted information) from the received information and forwards the extracted information to the list generation module 430. The list generation module may then create a list of the inputted/uploaded properties and the warranty options (e.g., appliances and utilities to cover, length of warranty, etc.) based upon the extracted information.

After the user selects which properties they wish to obtain warranty coverage for and the corresponding warranty features/options, a material preparation module 440 may begin to prepare the customized marketing and sales material discussed above. Additionally, a cost-generation module 450 may generate and calculate the cost of the warranty. A warranty module 460 may then provide the bank/mortgage company/agent with the warranty and/or materials. As described above, once the warranty module 460 provides the seller/bank/mortgage company with the warranty and/or marketing materials, the bank/mortgage company/listing agent may market the property as “under warranty,” which improves the value and salability of the property, thus allowing the seller/bank/mortgage company/listing agent to sell the property faster and for a higher price. Additionally or alternatively, once the property is sold, the warranty module 460 may initiate the warranty coverage for the property.

Some embodiments may also include a billing module 470. As the name suggests, the billing module 470 may bill the seller/bank/mortgage company for the warranty. As described above, the seller/bank/mortgage company is not typically billed until the property is sold. Accordingly, the billing module 470 may withhold billing for the warranty until the property is sold (e.g., until the system receives the closing information from the seller/bank/mortgage lender/closing agent). For example, the billing module 470 may not bill the seller/bank/mortgage company for the warranty until the day of the closing or sometime thereafter.

It should be noted that the above described modules need not be located at a single site (e.g., the home warranty provider, print broker, etc.). For example, as described above, some embodiments of the present invention may utilize print brokers or other entities to prepare the marking and sales materials. To that end, the material preparation module 440 may be located at the print broker 260 and the relevant information (e.g., the extracted information, the warranty information, etc.) may be transferred to the print broker 260, where the customized materials may be generated/prepared.

In accordance with other embodiments, the invention may be implemented as a computer program product for use with a computer system, such as the workstations 210/212/214 shown in FIG. 2. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may either be a tangible medium (e.g., optical or analog communications lines) or a medium implemented with wireless techniques (e.g., microwave, infrared or other transmission techniques). The series of computer instructions embodies all or part of the functionality previously described herein with respect to the system. For example, the series of computer instructions may be a computer program that may be installed on one or more of the workstations 210/212/214. The installed program may then perform the functions described above. For example, the software program may present the user with a graphical interface and a series of templates to facilitate the necessary data input and selection of home warranty options. The software program may then calculate the appropriate warranty costs.

Those skilled in the art should appreciate that such computer instructions/software programs can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer systems (e.g., on system ROM or fixed disk), or distributed from a server or electronic bulletin board over the network (e.g., the Internet or World Wide Web).

In accordance with one exemplary embodiment of the present invention, the home warranty provider 230 may receive a “preload file” from a user (e.g., the bank, mortgage lender, real estate agent, or Freddie Mac). The preload file may include a IDs and the IDs received in these files may be into various embodiments of the system described above. The file may also be used as a means for Vendor management to ensure that the home warranty provider 230 has vendors in the areas in which the properties are located.

Any payments received by the home warranty provider may be deposited into a bank lockbox, these payments and any ‘Payment Authorization Forms’ may be scanned and the images may be accessed online (e.g., over the global communications network 220) by the home warranty provider. Initially, the images may be used to do enrollments and process payments manually. At a later date the home warranty provider 230 may receive a flat file from the bank which can be used as an enrollment file and to process payments.

In some embodiments, it may be assumed that the client's unique number (e.g., their Asset ID) will be received in the preload and enrollment files and mapped to a loan number field. Additionally, it may be assumed that the preload file from the seller and the enrollment file from the bank may be received in the same format every time. If not available, it may be assumed that the Mailing and Billing addresses are the same as the property address.

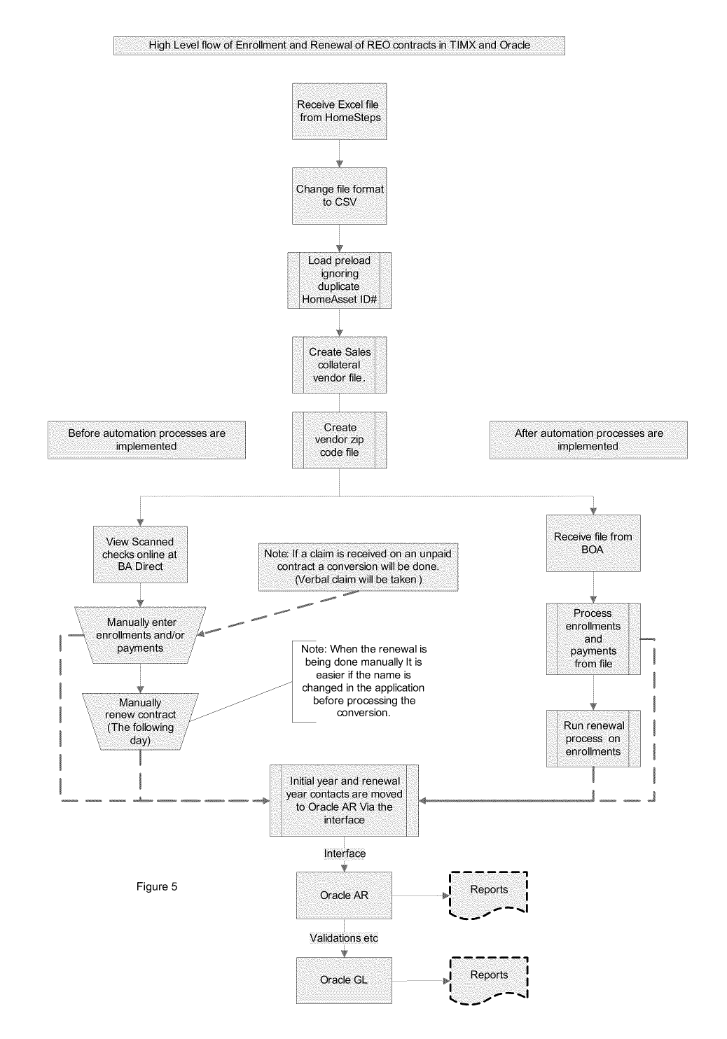

In general, exemplary embodiments of the present invention may perform the following: load a preload file from the seller, create a file for sales fulfillment vendor, create a zip code file for vendor management, load enrollment files from the bank, create a procedure to process payments in file from the bank, create a procedure to automatically renew 1^{st} year contracts to 2^{nd} year, send fulfillment files for contracts, automatically generate a claim handler task, automatically generate a closed loop task, and create an error log report and system report. FIG. 5 shows a high level flow diagram of various embodiments of the present invention

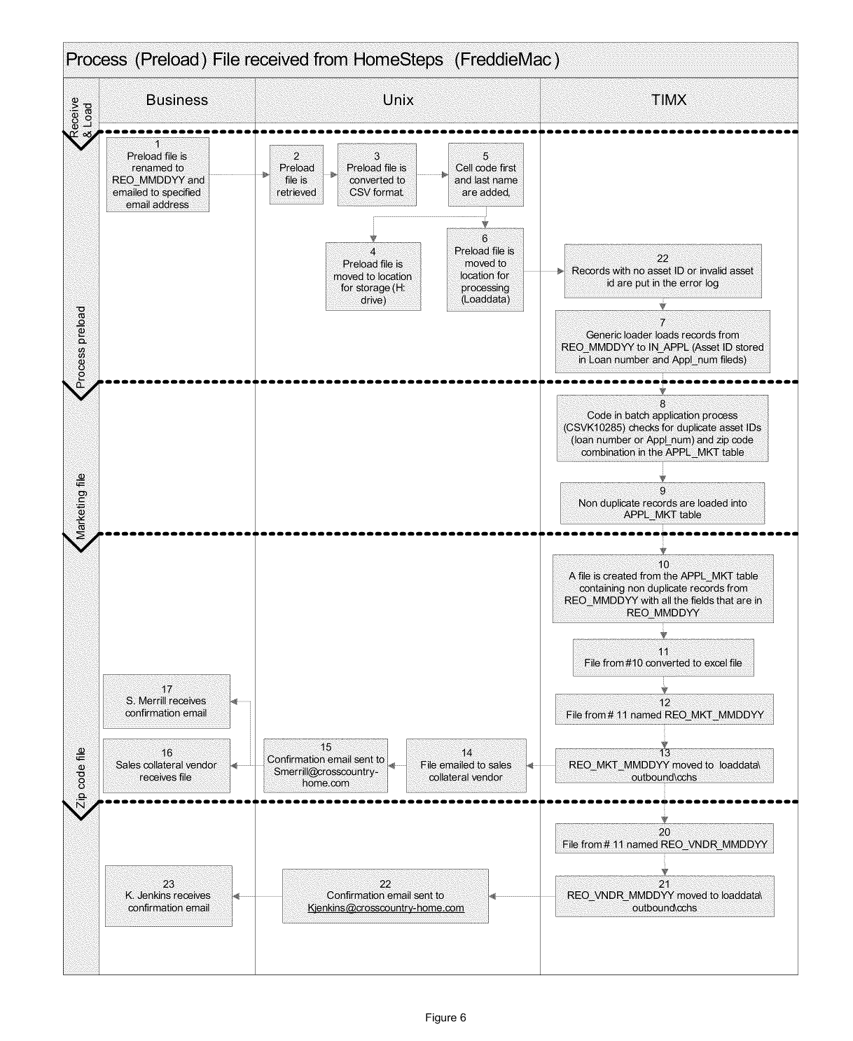

Additionally, as shown in FIG. 6, various embodiments of the systems and methods described above may receive and prepare the excel files received from the seller to be processed as a preload file. For example, the file may be received via email from Freddie Mac and the home warranty provider 230 may rename the file (e.g., to REO_MMDDYY) and forward the file for further processing. Additionally, the format of the file may be changed (e.g., from excel format to CSV format) and the cell code and default first and last names may be added. It should be noted that records in the file that have already been loaded into the application need not be loaded again. The Asset ID which will be loaded into loan number and application number fields and the property zip code may be used to identify the duplicate records. The system and/or method may than map the file (e.g., the preload file or the converted preload file) to the application. For example, the mapping may be as follows:

| Field # | Home Steps FILE | TIMX |
|---|---|---|
| 1 | ID_AST | LOAN_NBR |
| 1 | ID_AST | APPL_NUM |
| 2 | ADDR_STRT | MAIL_ADDR1 |
| 3 | ADDR_CITY | MAIL_CITY |
| 4 | ADDR_ST | MAIL_STATE_CODE |
| 5 | ADDR_ZIP_CD | MAIL_ZIP_CODE |
| 2 | ADDR_STRT | PRPTY_ADDR1 |
| 3 | ADDR_CITY | PRPTY_CITY |
| 4 | ADDR_ST | PRPTY_STATE_CODE |
| 5 | ADDR_ZIP_CD | PRPTY_ZIP_CODE |
| 6 | BROKER COMPANY | CLIENT_VAR_VALUE1 |
| 7 | BROKER NAME | CLIENT_VAR_VALUE2 |
| 8 | DT_INIT_LIST | CLIENT_VAR_VALUE3 |
| 9 | AMT_LIST_PRCE | CLIENT_VAR_VALUE4 |
| 10 | BROKER STREET | CLIENT_VAR_VALUE5 |
| 11 | BROKER CITY | CLIENT_VAR_VALUE6 |
| 12 | BROKER STATE | CLIENT_VAR_VALUE7 |
| 13 | BROKER ZIP | CLIENT_VAR_VALUE8 |

If the file is missing information, various default values may be used to populate the application fields. For example, the system/method may use the defaults below. Additionally or alternatively, the cell code, first and last name field values below will be added to the file when it is converted to a CSV file.

| VALUE | TIMX |
|---|---|
| FRDMAC | CLIENT_ID |
| A99183 will be set by procedure based on | CCM_ID |
| client ID | |
| FRDMAC101 if property state is not Arizona | CELL_CODE |
| FRDMAC102 if property state is Arizona | |
| GSA-REO | INDUSTRY_CODE |
| HOME | P_FIRST_NAME |
| STEPS | P_LAST_NAME |

After the processes described above is completed, the records may be loaded into the application tables using a preload process. Additionally, a validation rule may be created to check the length of the asset ID. If a record received does not have an asset IL) or the asset ID is present and does not pass the validation rules, a record may be placed in an error log. Handling of these records will be done manually. For example, the errors may be viewed in a ‘Batch Application’ screen accessed from the website and/or server. An error report log may be created and may include the following fields:

LOAN_NUMBER
APPL_NUM
CLIENT_ID
CCM_ID
CELL_CODE
INDUSTRY_CODE
P_FIRST_NAME
P_LAST_NAME
PRPTY_ADDR1
PRPTY_CITY
PRPTY_STATE_CODE
PRPTY_ZIP_CODE
CLIENT_VAR_VALUE1
CLIENT_VAR_VALUE2
CLIENT_VAR_VALUE3
CLIENT_VAR_VALUE4
CLIENT_VAR_VALUE5
CLIENT_VAR_VALUE6
CLIENT_VAR_VALUE7
CLIENT_VAR_VALUE8

Some embodiments of the present invention may also create a file will be created from the received file (e.g., by extracting various information from the received information/file). This created file may be sent to a sales collateral vendor (e.g., the print broker 260). The file may include only new properties that have not been received before in previous preload files. The file may be in Excel format and contain all the fields received in the preload file or a subset of the fields from the preload file. Once the print broker 260 receives the file, they may sent a confirmation receipt back to the home warranty provider 230.

The system/method may also create a file from the received files/information that may be used by vendor management to ensure vendor coverage of the zip codes (e.g., the zip codes of the distressed properties). The file may include new properties that have not been received before in previous preload files. The file may be in a variety of formats, for example, in excel format. Once the file is created and stored, a confirmation message may be generated and/or sent.

In some embodiments, the application table need not be purged of the applications. For example, the application table may be purged on a scheduled basis. It is important to note that suppressing the purging of the applications is necessary so that duplicates can be checked in subsequent preload files.

As mentioned above, payments may be placed in a bank lock-box. Some embodiments may process the file received from the bank lock box and convert the application to an enrollment using the asset id and the property zip code to match the record (e.g., the asset id will be in the loan number and the application number fields in the application record.) If there is no asset ID available for a record in the file from the bank, the conversion enrollment/conversion will not be done, an entry may be made to an exception report, and funds may be placed in (client) suspense. If the asset ID and/or the zip code does not match an asset ID that is already in the application file, the system/method will not create an enrollment or convert the application, an entry may be made to an exception report, and funds may be placed in (client) suspense.

If the asset ID and property zip code matches one in the system and no name is available in the file from the bank the first name may be loaded in the HOME field and the last name is loaded as BUYER the buyer field. If only the First Name is available in the file from the bank, the First Name is loaded as <FIRSTNAME> and the Last Name is loaded as BUYER. If only the Last Name is available in the file from BOA the First Name is loaded as HOME and the Last Name is loaded as <LAST_NAME>. If the middle name is not available in the file from the bank, it is loaded as NULL. If the check date is greater than the system date the enrollment/conversion may not be done, an entry will be made to an exception report, and any funds may be placed in (client) suspense. If the conversion is not successful no enrollment/conversion may be done, an entry will be made to an exception report, and funds will be placed in (client) suspense.

The system/method may also create a discoverer report with the errors from this process. If the application has already been converted continue with process (b) (e.g. verbal claim). Mapping of the enrollment file received from the bank is as follows:

| Field # | Field | Size | Type | TIMX |
|---|---|---|---|---|
| 1 | ASSET ID | 6 | VARCHAR2 | LOAN_NUMBER & APPL_NUM |
| 2 | P_FIRST_NAME | 30 | VARCHAR2 | P_FIRST_NAME |
| 3 | P_MIDDLE_NAME | 30 | VARCHAR2 | P_MIDDLE_NAME |
| 4 | P_LAST_NAME | 30 | VARCHAR2 | P_LAST_NAME |
| 5 | S_FIRST_NAME | 30 | VARCHAR2 | S_FIRST_NAME |
| 6 | S_MIDDLE_NAME | 30 | VARCHAR2 | S_MIDDLE_NAME |
| 7 | S_LAST_NAME | 30 | VARCHAR2 | S_LAST_NAME |
| 8 | PROP_ADDRESS1 | 40 | VARCHAR2 | PROP_ADDRESS1 |
| 9 | PROP_CITY | 30 | VARCHAR2 | PROP_CITY |
| 10 | PROP_STATE | 2 | VARCHAR2 | PROP_STATE |
| 11 | PROP_ZIPCODE | 5 | VARCHAR2 | PROP_ZIPCODE |
| 12 | PROP_ZIPCODE4 | 4 | VARCHAR2 | PROP_ZIPCODE4 |
| 13 | CHK_NUM | 30 | VARCHAR2 | CHK_NUM |
| 14 | CHK_DATE | 10 | DATE | CHK_DATE |
| 15 | CHK_MAKER | | | CHK_MAKER |
| | COMP_NAME | 40 | VARCHAR2 | COMP_NAME |
| 16 | CLOSING_DATE | 10 | DATE | CLOSING_DATE & EFF_DATE |
| 17 | AMOUNT | 15,2 | NUMBER | PMT_AMT |

Default fields for the enrollment are as follows:

| VALUE | TIMX |
|---|---|
| FRDMAC | Client ID |
| A99183 | CCM ID |
| 15964 if property state is not Arizona | Prod gen seq |
| 16004 if property state is Arizona | |
| FRDMAC101 if property state is not Arizona | Cell Code |
| FRDMAC102 if property state is Arizona | |
| GSA-REO | Industry |
| Invoice | Billing mechanism |

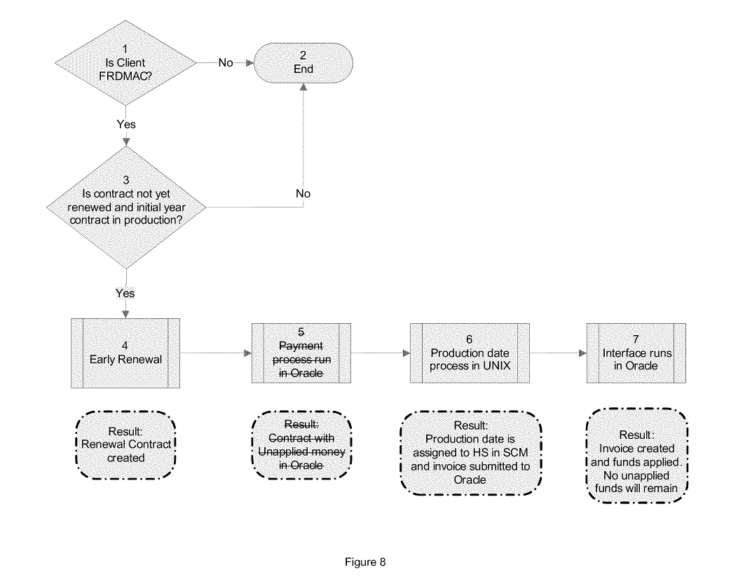

The above described system/method may also run a procedure will be run every day to perform automatic renewals of home warranty contracts for which 1^{st} and 2^{nd} year payments have been received at the time of enrollment. For example, one embodiment of this process is shown in FIG. 8.

In accordance with various embodiments a claim handler task may be triggered when a claim is placed on a contract (for example, with the industry code=GSA−REO). (This will be triggered for claims entered manually or through the IVR). The task may be initiated when a claim is created and the claim may be closed manually. Many of the parameters needed to create the claim handler task may be taken from the claim.

Additionally embodiments may initiate a closed loop task for the home warranty contracts. For example, the task may be initiated 2 days after the claim initiation date for claims that are still open (e.g., those that have a status of OPEN). During this task, a home warranty associate may call the customer to determine if a job has been completed. If customer indicates that the job has been completed the associate closes the task. If the customer indicates the job has not been completed the associate calls the vendor to set up another appointment or takes whatever other action is appropriate. The associate then follows up until the job is complete and then closes the task.

Some embodiments may create a file for all active and inactive (future effective date) home warranty contracts (Even if payment has not been received on the contracts they should be included in the report). The file may include: the title of the report, the asset ID, date enrollment created, who created the enrollment, the property address (Street, city, state, zip), a list Start Date (CLIENT_VAR_VALUE3), the contract number, check number, check date and amount, the closing date, and the status.

It is important to note that, in order to protect the privacy of the buyer, the files being received from the seller (e.g., via email) may not contain any personal information such as credit card or bank account numbers. Additionally, as information is transmitted within the system, the files may be encrypted.

Although the above discussion discloses various exemplary embodiments of the invention, it should be apparent that those skilled in the art can make various modifications that will achieve some of the advantages of the invention without departing from the true scope of the invention.

What is claimed is:

1. A system for accelerating the sale of a property comprising:
a warranty module for providing to a seller having a plurality of distressed properties a warranty on at least one of the plurality of distressed properties; and
a billing module for billing the seller for the warranty on the at least one of the plurality of distressed properties once the at least one of the plurality of distressed properties is sold.

2. A system according to claim 1, wherein a cost of the warranty is included in a sale price of the at least one of the plurality of distressed properties.

3. A system according to claim 1, the system further comprising:
an information receiving module for receiving information regarding the plurality of distressed properties from a system user;
an extraction module for extracting a subset of the property information from the received information; and
a list generation module, the list generation module generating a list of the plurality of distressed properties, the list including the extracted information and warranty options for at least one of the plurality of distressed properties.

4. A system according to claim 3, the system further comprising:
a material preparation module, the material preparation module preparing customized marketing and sales materials based, at least in part, upon the extracted property information and at least one warranty option selected by the system user.

5. A system according to claim 4, wherein the user is at least one of a bank, the mortgage lender, government agency, investors, or a real estate agent listing the property.

6. A system according to claim 3, the system further comprising:
a cost generation module, the cost generation module calculating a cost of the warranty based, at least in part, upon the extracted property information and at least one warranty option selected by the system user from the list of warranty options, the billing module billing the seller the calculated cost of the warranty.

7. A system according to claim 1, wherein a term of the warranty begins after a closing of the at least one of the plurality of distressed properties, the warranty module initiating the warranty term after closing.

8. A computer-implemented method for accelerating the sale of a property comprising:
receiving, within a computer, property information regarding at least one distressed property from a user over a global communication network;
extracting, within a computer process, a subset of the received information;
preparing, within a computer process, customized marketing and sales materials for the at least one distressed property based, at least in part, upon the extracted information, the customized marketing and sales materials aiding the user in accelerating the sale of the property, the customized marketing and sales materials relating to warranty coverage for the at least one distressed property.

9. A method according to claim 8, the method further comprising:
generating, in a computer process, a list of warranty features for the at least one distressed property; and
displaying the list of warranty features for the at least one distressed property, thereby allowing a user to select at least one warranty feature for the at least one distressed property, the customized marketing and sales materials being based upon the selected warranty features.

10. A method according to claim 9 further comprising:
calculating, in a computer process, a cost of the warranty based, at least in part upon the selected warranty features.

11. A method according to claim 10, the method further comprising:
billing, using a computer, an entity for the calculated cost of the warranty after the at least one distressed property is sold; and
initiating, in a computer process, warranty coverage for the at least one distressed property, the warranty coverage including the selected warranty features, the warranty coverage starting after the at least one property sold.

12. A method according to claim 11, wherein the entity is at least one of a bank, a government agency, an investor, and a mortgage lender.

13. A method according to claim 9, wherein the list of warranty features includes at least one selected from the group consisting of a list of appliances contained within the distressed property, a list of utilities equipment contained within the distressed property, a length of warranty coverage, and warranty deductible options.

14. A method according to claim 8, wherein the user is at least one selected from the group consisting of a bank, a mortgage lender, and a listing agent.

15. A system for accelerating the sale of a property comprising:
means for providing to a seller having a plurality of distressed properties a warranty on at least one of the plurality of distressed properties; and
means for billing the seller for the warranty of each of the plurality of distressed properties once the at least one of the plurality of distressed properties is sold

16. A system according to claim 15, wherein a cost of the warranty is included in a sale price of the at least one of the plurality of distressed properties.

17. A system according to claim 15, wherein the warranty increases the value and salability of the plurality of distressed properties.

18. A system according to claim 15, wherein the warranty does not cover at least one of missing appliances, missing home systems, rust and corrosion, and abuse to the distressed property.

19. A system according to claim 18, wherein abuse includes intentional or neglectful damage to at least one of air conditioning systems, heating system, kitchen appliances, and laundry appliances.

20. A system according to claim 15, wherein a term of the warranty begins at a closing of the at least one of the plurality of distressed properties.

21. A computer program product for use on a computer system for accelerating the sale of a property, the computer program product comprising a computer readable medium having computer readable code thereon, the computer readable program code comprising:
computer code for receiving property information regarding at least one distressed property from a user over a global communication network;
computer code for extracting a subset of the received information;
computer code for preparing customized marketing and sales materials for the at least one distressed property based, at least in part, upon the extracted information, the customized marketing and sales materials aiding the user in accelerating the sale of the property and describing warranty coverage for the at least one distressed property.

22. A computer program product according to claim 21 further comprising:
computer code for generating a list of warranty features for the at least one distressed property; and
computer code for displaying the list of warranty features for the at least one distressed property, thereby allowing a user to select at least one warranty feature for the at least one distressed property, the customized marketing and sales materials describing the selected warranty features.

23. A computer program product according to claim 22 further comprising:
computer code for calculating a cost of the warranty based, at least in part upon the selected warranty features.

24. A computer program product according to claim 23, the method further comprising:
computer code for billing an entity for the calculated cost of the warranty after the at least one distressed property is sold; and
computer code for initiating warranty coverage for the at least one distressed home, the warranty coverage including the selected warranty features, the warranty coverage starting after the at least one property sold.
